(19) United States
(12) Patent Application Publication
(10) Pub. No.: US 2012/0226642 A1
(43) Pub. Date: Sep. 6, 2012

(54) METHOD AND APPARATUS FOR CONSIDERING MULTI-USER PREFERENCE BASED ON MULTI-USER-CRITERIA GROUP

(75) Inventors: Nam-Hoon Kim, Suwon-si (KR); Hee-Yong Youn, Suwon-si (KR); Dae Gun Kim, Suwon-si (KR)

(73) Assignees: SUNGKYUNKWAN UNIVERSITY FOUNDATION FOR CORPORATE COLLABORATION, Suwon-si (KR); SAMSUNG ELECTRONICS CO., LTD., Suwon-si (KR)

(21) Appl. No.: 13/411,440

(22) Filed: Mar. 2, 2012

(30) Foreign Application Priority Data
Mar. 3, 2011 (KR) 10-2011-0018828

(51) Int. Cl. G06F 15/18

(52) U.S. Cl. 706/12

(57) ABSTRACT

A method and apparatus for decision making considering a multi-user preference based on a multi-user-criterion group are provided. The method includes determining user information using ontology, determining an appointed area and an appointed category based on the user information, determining appointed candidate places belonging to the appointed area and appointed category, and determining a final appointed place among the appointed candidate places based on a user preference.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Mar. 3, 2011 and assigned Serial No. 10-2011-0018828, the entire disclosure of which is hereby incorporated by reference.

### TECHNICAL FIELD OF THE INVENTION

The present disclosure relates to a modeling method and application for multi-criterion decision making considering various user's preference in decision making between multiple users in a ubiquitous environment, and an apparatus for the same.

### BACKGROUND OF THE INVENTION

Because decision making centering on a single decision maker cannot reflect points of view of various people, there is a problem that opinions of various people are not unified into a decision making process. In addition, there is a problem that the fuzziness and ambiguity of data make it difficult to apply an existing multi-criterion decision making scheme.

Also, in a general multi-criterion decision making method, result is come out centering on a decision maker's subjectivity or preference in estimation or weight determination, so there is a problem that real life cannot be reflected.

### SUMMARY OF THE INVENTION

To address the above-discussed deficiencies of the prior art, it is a primary aspect of the present disclosure is to provide a method and apparatus for decision making considering a multi-user preference based on a multi-user-criterion group.

Another aspect of the present disclosure is to provide a method and apparatus for better decision making using situation information in a mobile environment.

A further aspect of the present disclosure is to provide a multi-criterion decision making method and apparatus for analyzing situation information, modeling the preference of a plurality of users on the basis of an individual user's preference, and recommending the most suitable alternative in a mobile environment.

Yet another aspect of the present disclosure is to provide a method and apparatus for, when a plurality of users make an appointment, solving an inconvenience about communication and real time and recommending an appointed place of a less scope considering the human relationship and preference of the plurality of users, thereby being capable of solving a difficulty of selection.

The above aspects are achieved by providing a method and apparatus for decision making considering a multi-user preference based on a multi-user-criterion group.

According to one aspect of the present disclosure, a method for decision making in a decision making apparatus considering a multi-user preference based on a multi-user-criterion group is provided. The method includes determining user information using ontology, determining an appointed area and an appointed category based on the user information, determining appointed candidate places belonging to the appointed area and appointed category, and determining a final appointed place among the appointed candidate places based on a user preference.

According to another aspect of the present disclosure, an apparatus for decision making considering a multi-user preference based on a multi-user-criterion group is provided. The apparatus includes a communication modem, a controller, and a storage unit. The communication modem communicates with other nodes. The controller determines user information using ontology, determines an appointed area and an appointed category based on the user information, determines appointed candidate places belonging to the appointed area and appointed category, and determines a final appointed place among the appointed candidate places based on a user preference. The storage unit stores the user information and user preference.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A, 1B, and 1C illustrate a multi-criterion decision making operation process according to an exemplary embodiment of the present disclosure;

FIG. 2 illustrates a message flow for a multi-criterion decision making operation process according to an exemplary embodiment of the present disclosure;

FIG. 3 illustrates a process of determining a position center of each user in a place decision step according to an exemplary embodiment of the present disclosure;

FIG. 4 illustrates a user interface of an appointed place recommendation service according to an exemplary embodiment of the present disclosure;

FIG. 5 illustrates a process when extracting user information from ontology according to an exemplary embodiment of the present disclosure;

FIG. 6 illustrates a diagram describing the relationship between each user and criterion when carrying out multi-criterion decision making according to an exemplary embodiment of the present disclosure;

FIG. 7 illustrates a preference order decision process according to an exemplary embodiment of the present disclosure; and

FIG. 8 illustrates a construction of a decision making apparatus according to an exemplary embodiment of the present disclosure.

### DETAILED DESCRIPTION OF THE INVENTION

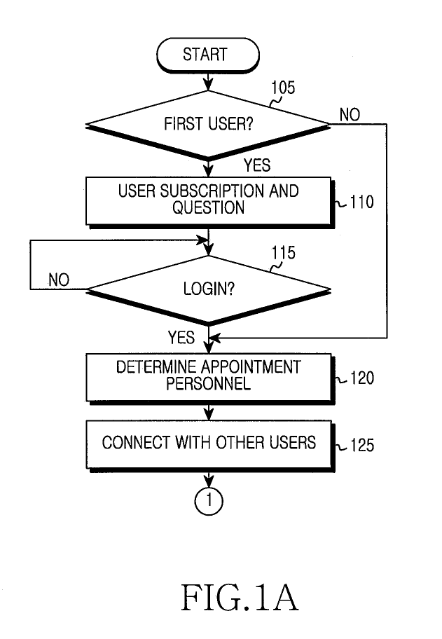

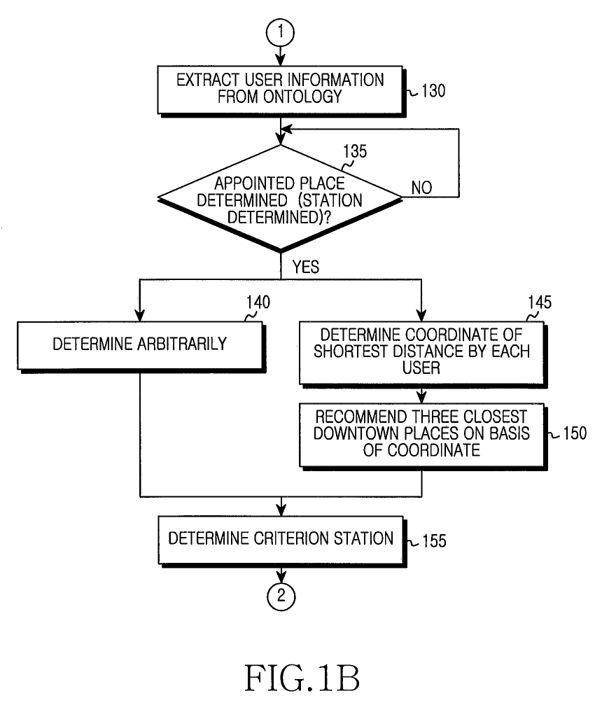

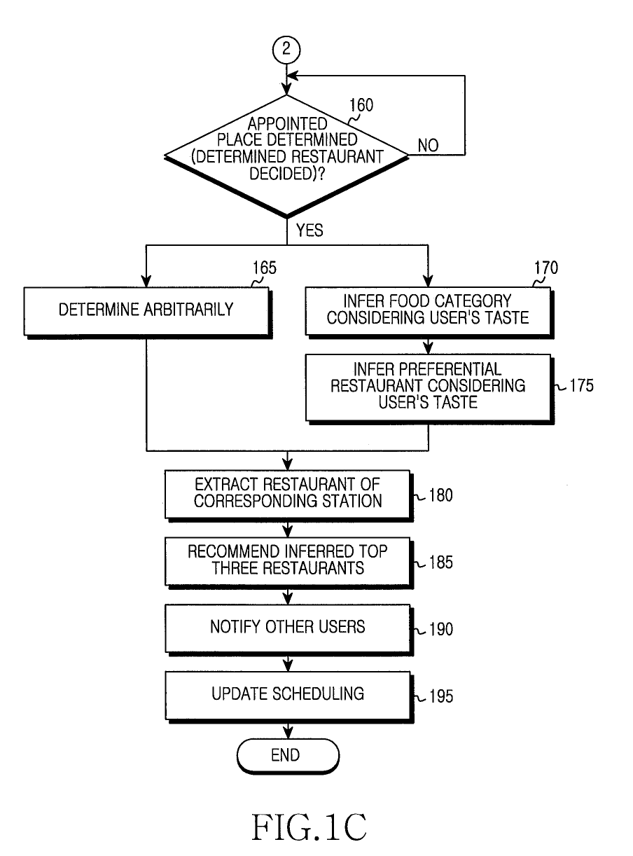

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

Preferred embodiments of the present disclosure will be described herein below with reference to the accompanying drawings. In the following description, well-known functions or constructions are not described in detail since they would obscure the disclosure in unnecessary detail. In addition, terms described below, which are defined considering functions in the present disclosure, can be different depending on user and operator's intention or practice. Therefore, the terms should be defined on the basis of the disclosure throughout this specification.

A method and apparatus for decision making considering a multi-user preference based on a multi-user-criterion group according to an exemplary embodiment of the present disclosure are described below.

The present disclosure proposes a situation recognition computing method and apparatus for extracting user data based on ontology and recommending a service using both the determined user data and a multi-user decision making method.

The present disclosure applies fuzzy and entropy to model the ambiguity of data and, on the basis of situation information such as an appointed time and place of the user, a traffic situation that the user encounters, a friend's position and the like in a mobile environment, recommends the best appointment information to a user in an efficient and optimized scheme.

Situation recognition computing represents making interaction between a user and a computer more effective, by making active use of information on a user's situation and enabling the computer to understand the user's situation.

Here, the situation information necessary for situation recognition represents all information available to represent a characteristic of the user's situation. And, an optimized service is provided considering several users' preference.

A multi-criterion decision making model according to an exemplary embodiment of the present disclosure makes use of a group decision making scheme that uses a fuzzy theory and entropy. This applies the ambiguity of the fuzzy theory and the concept of an information amount of entropy, thereby making a solution to subjectivity data including decision maker's vulnerable information more realistic.

As one exemplary implementation for this, a restaurant recommendation scenario in an appointment management service is described as follows.

Firstly, the present disclosure extracts user information such as an age of a user, a job title and the like, using ontology. Here, the ontology is a model expressing a thing on which people reach an agreement through mutual discussion on seeing, listening, feeling, and thinking about the world, in a conceptual and computer-treatable form. The ontology is a technology defining the type of concept or the constraints on use.

Secondly, the present disclosure recommends a preferential food category using a multiple decision making scheme, on the basis of the extracted user data.

Thirdly, with an input factor being the recommended category and a station selected by a mediator, the present disclosure extracts a list of restaurants using a search engine (e.g., a ‘Naver’ Application Program Interface (API) or a ‘Daum’ API).

Fourthly, based on the plurality of extracted restaurants, the present disclosure recommends the small number of restaurants most suitable to an appointment using Technique for Order Preference by Similarity to Ideal Solution (TOPSIS).

This is described below in more detail.

In a case where a user gains initial access to the present service, it is required to guarantee much user information (i.e., a job title of a user, an age, and a preferential food) through questions to the maximum.

After that, the mediator determines personnel who will take part in an appointment. At this time, a criterion of the recommendation personnel is based on a person who is executing the present service and is listed in an address book.

Next, if the mediator determines the personnel, the present disclosure extracts each user information through existing built ontology. At this time, the extracted information can be helpful in giving a weight when human relationship between respective users is extracted to make an appointment.

And, when recommending an appointed place, a corresponding process is carried out through the following three steps.

In the first step, the present disclosure recommends stations. Assuming that personnel associated with an appointment are three in number, the present disclosure extracts a coordinate of the shortest distance that the three persons can reach and, on a basis of the extracted coordinate, recommends total three closest downtown stations.

In the second step, if one of the three closest downtown stations is determined, the present disclosure performs inference based on the information on the three users, and determines a food category, i.e., one of Western food, Japanese food, Korean food, and Chinese food in the present service. At this time, the present disclosure can use TOPSIS that is one of multiple decision making techniques. If going through this process, the present disclosure determines a plurality of restaurants that correspond to the recommended food category and are placed in the selected downtown station.

In the third step, the present disclosure selects top three restaurants suitable to preference of the three users, among the plurality of listed restaurants.

After the above three steps, the present disclosure finally determines an appointed place through mutual dialogues between the mediator and the users. If detailed information (i.e., a time, a place, a restaurant position) is input to scheduler appointment information of each user, an apparatus of the present disclosure sends a notification message to the respective users at the same time and then, the appointment is completed.

FIGS. 1A, 1B, and 1C are a flowchart illustrating a multi-criterion decision making operation process according to an exemplary embodiment of the present disclosure.

Referring to FIGS. 1A, 1B, and 1C, in a case where a present user is an initial access user in step 105, an apparatus of the present disclosure performs a subscription process for the user in step 110. After that, in step 115, the apparatus determines if it performs a login process for the user. The apparatus of the present disclosure can communicate with a server and perform the subscription process for the user.

If it is determined in step 105 that the present user is not the initial access user, the apparatus jumps to step 115 and performs the login process for the user.

Next, in step 120, the apparatus determines appointment personnel through a user input. After that, in step 125, the apparatus can connect with devices of other appointment personnel excepting the user.

At this time, a mediator determines personnel who will participate in an appointment. At this time, a criterion of the recommendation personnel is based on a person who is executing the present service and is listed in an address book.

After that, if the mediator determines the personnel, in step 130, the apparatus extracts information of each user through existing built ontology. At this time, the extracted information can be helpful in giving a weight when a human relationship between users is extracted to make an appointment.

Next, if it is determined in step 135 that the apparatus determines an appointed place or station, the apparatus determines a criterion station or area in step 155.

To determine the appointed area or station, the apparatus can arbitrarily determine a corresponding area or station in step 140. Alternatively, the apparatus can determine a coordinate of the shortest distance by each user in step 145 and, on the basis of the determined coordinate, recommend the closest downtown, for example, three places in step 150.

If it is determined in step 160 that the appointed area or station is determined, the apparatus performs a process of determining a detailed place (e.g., a restaurant).

In this process, the apparatus arbitrarily determines a detailed place (e.g., a restaurant) in step 165. Alternatively, the apparatus infers a food category considering a user's taste in step 170 and infers a preferential restaurant considering a user's preference in step 175.

Next, the apparatus extracts restaurants located in a corresponding station among the inferred preferential restaurants in step 180 and, among the extracted restaurants, extracts top three restaurants according to preference in step 185.

After that, in step 190, the apparatus informs the other users of the determined top three restaurants and, in step 195, updates scheduling of the apparatus.

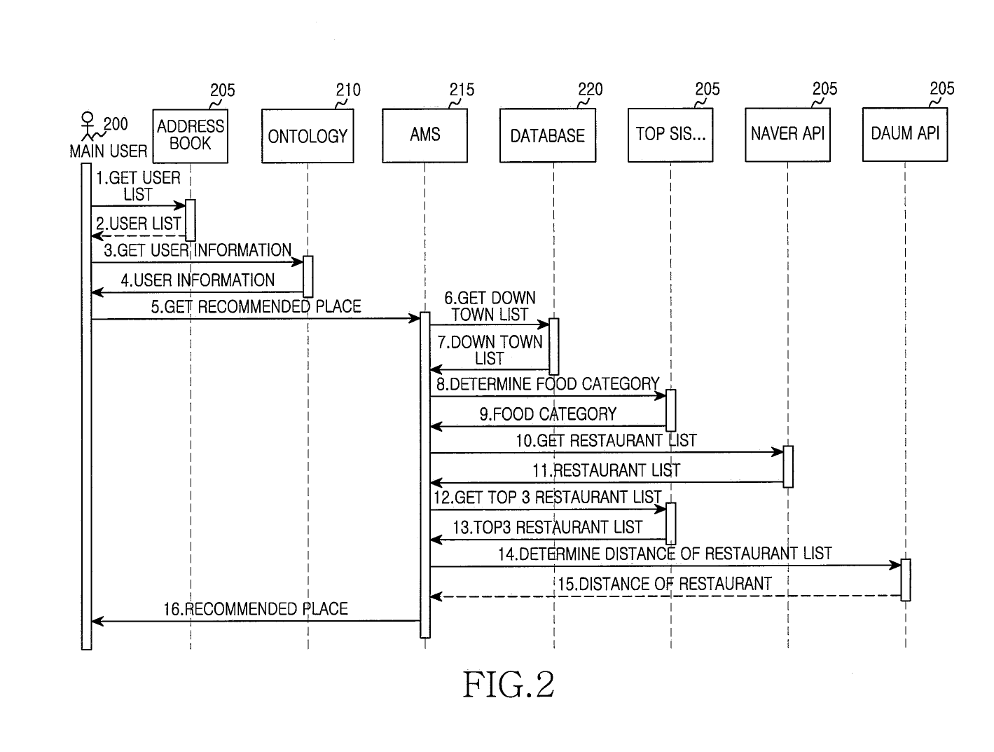

FIG. 2 illustrates a message flow for a multi-criterion decision making operation process according to an exemplary embodiment of the present disclosure.

Referring to FIG. 2, a mediator (i.e., a main user) 200 determines personnel who will participate in an appointment. At this time, a criterion of the recommendation personnel is based on a person who is executing the present service and is listed in an address book 205. After that, if the mediator determines the personnel, the apparatus extracts information of each user through existing built ontology 210. At this time, the extracted information can be helpful in giving a weight when human relationship between users is extracted to make an appointment (steps 1 to 4).

After that, on the basis of the extracted user data, the main user 200 performs a preferential food category recommendation process using a multiple decision making scheme (steps 5 to 16). A preferential food category can be called an appointed category.

In this process, an Address Matching System (AMS) 215 can instead perform the preferential food category recommendation process using the multiple decision making scheme (steps 6 to 15).

In this process, the apparatus or AMS 215 can perform place decision through a database 220 (steps 6 and 7), food category decision through TOPSIS 225 of the present disclosure (steps 8 and 9), restaurant category acquisition through a Naver API 230 (steps 10 and 11), and distance acquisition a Daum API 232 (steps 14 and 15).

In the above process, a process of determining a position center of each user in the appointed place decision step is described as follows.

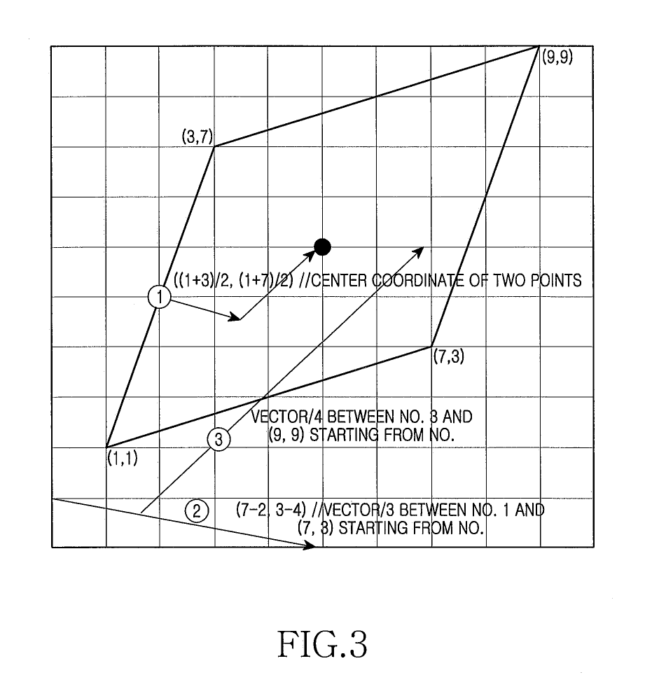

FIG. 3 illustrates a process of determining a position center of each user in a place decision step according to an exemplary embodiment of the present disclosure.

Referring to FIG. 3, when marking respective users with coordinates on a map, first, the present disclosure determines a central coordinate between arbitrary two coordinates ((3, 7) (7, 3)) and then, adds non-selected other coordinates one by one.

Next, the present disclosure adds vectors of the added coordinate and a selected another coordinate to an existing coordinate to determine a coordinate between points. This process is repeated until all coordinates are selected once. Also, the present disclosure moves a coordinate as much as a defined numerical value considering a weight between coordinates, from a final coordinate.

After that, a user interface of an appointed place recommendation service is described as follows.

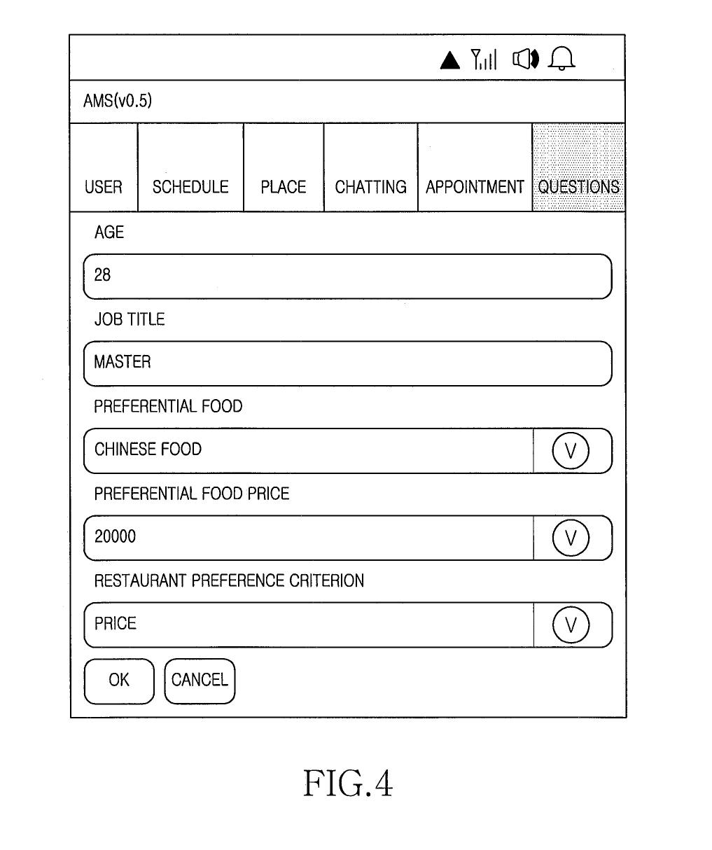

FIG. 4 illustrates a user interface of an appointed place recommendation service according to an exemplary embodiment of the present disclosure.

As in FIG. 4, an apparatus of the present disclosure can determine an age of a user, a job title, a preferential food, a preferential food price, a restaurant preference criterion and the like.

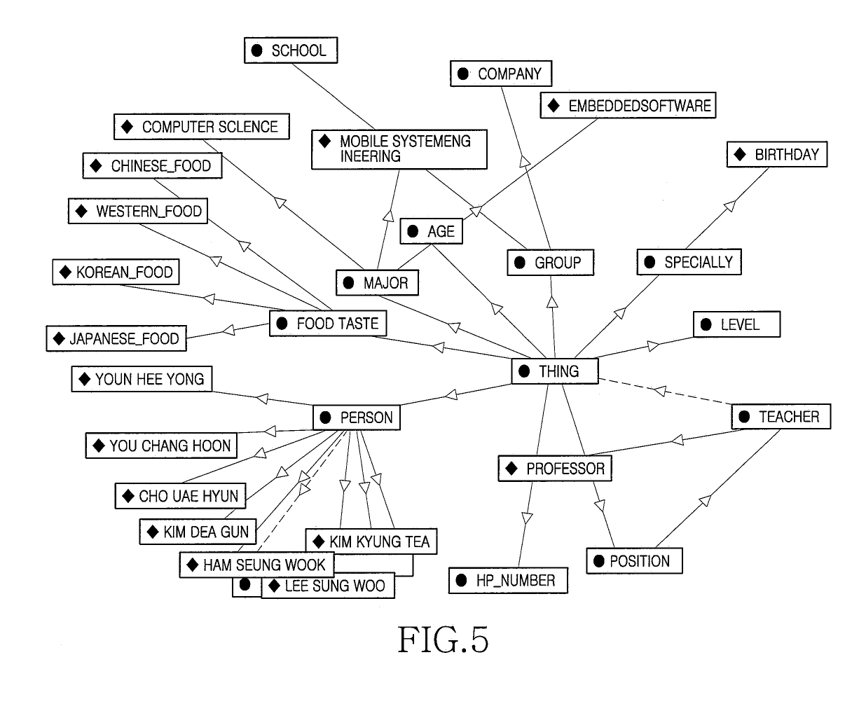

FIG. 5 illustrates a process when extracting user information from ontology according to an exemplary embodiment of the present disclosure.

Referring to FIG. 5, it can be appreciated that a user, a job title, a preferential food, a preferential food price, and a restaurant preference criterion and the like are determined at the time of extracting user information using ontology. And, it can be appreciated that even information of the user who selects the job title, the preferential food, the preferential food price, the restaurant preference criterion and the like is determined.

It is assumed that extracted data is given as in Table 1 below at the time of extracting user information. It can be appreciated that a preferential food of a user, an age, a job title, and a specialty have been recorded as in Table 1 below.

TABLE 1

| | Preferential food | Age | Job title | Specialty |
|---|---|---|---|---|
| LEE** | Korean food | 56 | Professor | X |
| HAN** | Chinese food | 36 | Doctorate | X |
| KIM** | Western food | 28 | Master | Birthday |

The apparatus of the present disclosure can perform update as in Table 2 below, using Table 1 above.

TABLE 2

| | Age | Job title | Specialty |
|---|---|---|---|
| Korean | Sum of ages of | Sum of job title | Sum of weights having |
| food | persons having | levels having | Korean food taste |
| | Korean food taste | Korean food | |
| | | taste | |
| Chinese | Sum of ages of | Sum of job title | Sum of weights having |
| food | persons having | levels having | Chinese food taste |
| | Chinese food | Chinese food | |
| | taste | taste | |
| Western | Sum of ages of | Sum of job title | Sum of weights having |
| food | persons having | levels having | Western food taste |
| | Western food | Western food | |
| | taste | taste | |
| Japanese | Sum of ages of | Sum of job title | Sum of weights having |
| food | persons having | levels having | Japanese food taste |
| | Japanese food | Japanese food | |
| | taste | taste | |

At this time, if giving a weight by criterion to Table 2 above, the apparatus can get a fixed recommendation. At weight giving, the apparatus can differently give a weight adaptive to an age or job title as in Table 3 below.

TABLE 3

| Weight object | Age | Job title | Specialty |
|---|---|---|---|
| Weight | 0.3 | 0.5 | 0.2 |

TABLE 4

| Weight object | Age | Job title | Specialty |
|---|---|---|---|
| Weight | 0.1 | 0.2 | 0.7 |

If giving weights as in Tables 3 and 4, the apparatus can get fixed recommendation results using TOPSIS, respectively. And, if using the weights of Table 3 above, the apparatus can get a recommendation order like Table 5 below.

TABLE 5

| | |
|---|---|
| 1: Korean food | 0.163328 |
| 2: Chinese food | 0.580584 |
| 3: Western food | 0.655515 |
| 3: Japanese food | 1.000000 |

And, if using the weights of Table 4 above, the apparatus can get a recommendation order of Table 6 below.

TABLE 6

| | |
|---|---|
| 1: Korean food | 0.168456 |
| 2: Chinese food | 0.779296 |
| 3: Western food | 0.893623 |
| 3: Japanese food | 1.000000 |

Accordingly, the apparatus can get a fixed recommendation order from the above weights.

Next, the apparatus can perform a restaurant recommendation process as the third step.

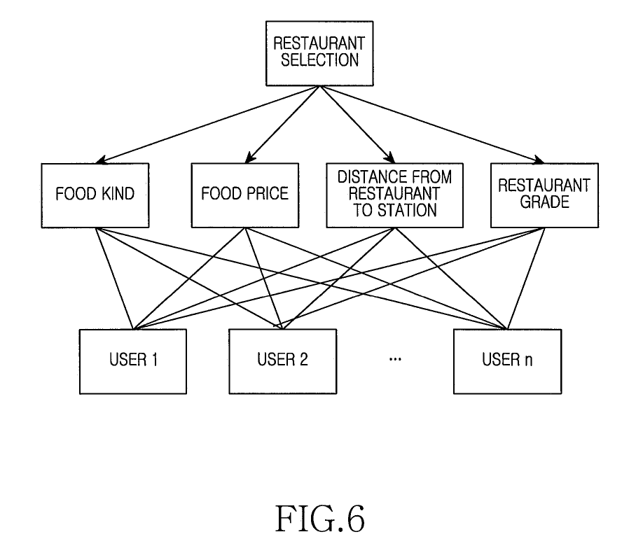

FIG. 6 illustrates a diagram describing the relationship between each user and criterion when carrying out multi-criterion decision making according to an exemplary embodiment of the present disclosure.

Referring to FIG. 6, the present disclosure uses a multi-criterion decision making scheme based on an extended TOPSIS. The present disclosure considers four criteria such as a restaurant by area, the kind of the restaurant, a food price zone of the restaurant, a distance with a recommended downtown station, a grade of each restaurant and the like and hereto, maps a relationship with a user. And, the present disclosure can use a model recommended from existing data and data that is determined through an API (for example, Naver or Daum).

The introduction of the multi-criterion decision making model into a food recommendation service is given as follows.

First, the multi-criterion decision making model applies TOPSIS, however, to compensate the disadvantage of the TOPSIS, the present disclosure uses an extended TOPSIS method.

In an aspect of estimation or weight determination, the existing TOPSIS includes ambiguous data of a decision maker. This ambiguous data is not suitable to model real life. That is, people's opinions or preference are ambiguous and cannot be expressed as accurate data.

Therefore, the present disclosure modeled ambiguity by a linguistic variable using each fuzzy theory and entropy in estimation or weight determination. The decision maker evaluates an estimation for each alternative by the linguistic variable. The estimation can be evaluated as in Table 7.

TABLE 7

| Linguistic predicate | Linguistic variable |
|---|---|
| Poor (P) | (0, 1, 3) |
| Medium Poor (MP) | (1, 3, 5) |
| Fair (F) | (3, 5, 7) |
| Medium Good (MG) | (5, 7, 9) |
| Good (G) | (7, 9, 10) |

Table 7 expresses an estimation of an alternative corresponding to each criterion of a decision maker, by Triangular Fuzzy Number (TFN). A detailed example is described below. Here, a decision matrix (D^{k}) of a decision maker (k) can be expressed as in Equation 1 below.

$${D}^{k} = [ \begin{matrix}{x}_{11}^{k} & {x}_{12}^{k} & … & {x}_{1 n}^{k} \\ {x}_{21}^{k} & {x}_{21}^{k} & … & {x}_{2 n}^{k} \\ … & … & … & … \\ {x}_{m 1}^{k} & {x}_{m 2}^{k} & … & {x}_{mn}^{k}\end{matrix} ] \qquad [ Eqn . 1 ]$$

In Equation 1, the xᵢⱼ^{k} is a triangular fuzzy number of a k^{th} decision maker.

The xᵢⱼ^{k}, which is a linguistic variable expressed by xᵢⱼ^{k}=(aᵢⱼ^{k}, bᵢⱼ^{k}, cᵢⱼ^{k}), represents an estimation of an alternative (Aᵢ^{k}) about a criterion (Cⱼ^{k}). In this case, operation of the triangular fuzzy number follows general operation of a fuzzy theory.

The present disclosure infers a food price zone of a restaurant, a distance with a recommended downtown station, and a grade of the restaurant every each decision maker using fuzzy operation.

It is assumed that decision makers are ‘D1’, ‘D2’, and ‘D3’, and selective restaurant alternatives by kind are Korean food (A1), Chinese food (A2), and Western food (A3), respectively. And, respective criteria, i.e., the food price zone of the restaurant, the distance with the recommended downtown station, and the grade of the restaurant are ‘C1’, ‘C2’, and ‘C3’.

Table 8 below represents actually determined data, and Table 9 represents data determined through doing mapping by linguistic variables.

TABLE 8

Criterion

| Decision maker | Alternative | C1 | C2 | C3 |
|---|---|---|---|---|
| D1 | A1 | 9000 | 750 | 5 |
| | A2 | 11000 | 550 | 9 |
| | A3 | 17000 | 800 | 8 |
| D2 | A1 | 12000 | 300 | 8 |
| | A2 | 10000 | 600 | 4 |
| | A3 | 16000 | 400 | 6 |
| D3 | A1 | 13000 | 850 | 5 |
| | A2 | 19000 | 450 | 7 |
| | A3 | 15000 | 650 | 3 |

TABLE 9

Criterion

| Decision maker | Alternative | C1 | C2 | C3 |
|---|---|---|---|---|
| D1 | A1 | MP | MG | F |
| | A2 | F | F | G |
| | A3 | G | MG | G |
| D2 | A1 | F | MP | G |
| | A2 | MP | F | MP |
| | A3 | MG | MP | MG |
| D3 | A1 | F | MG | F |
| | A2 | G | MP | MG |
| | A3 | MG | F | MP |

Here, when only TOPSIS and entropy are used while fuzzy is not used, the result is C1⁺=0.44, C2⁺=0.51, and C3⁺=0.53, and preference order is ‘A3’, ‘A2’, and ‘A1’.

A description using all of fuzzy, TOPSIS, and entropy is made below.

In step 1, the present disclosure determines a normalized decision making matrix using Equation 2 below.

R^{k}=└rᵢⱼ^{k}┘_{m×n} [Eqn. 2]

In Equation 2 above, the rᵢⱼ^{k} is determined using Equation 3 below.

$${r}_{ij}^{k} = \{ \begin{matrix}( \frac{{a}_{ij}^{k}}{{c}_{j}^{{k}^{*}}} \frac{{b}_{ij}^{k}}{{c}_{j}^{{k}^{*}}} , \frac{{c}_{ij}^{k}}{{c}_{j}^{{k}^{*}}} ) , & j ∈ B ; \\ ( \frac{{a}_{j}^{k =}}{{c}_{ij}^{k}} , \frac{{a}_{j}^{k =}}{{b}_{ij}^{k}} , \frac{{a}_{j}^{k =}}{{a}_{ij}^{k}} ) , & j ∈ C ;\end{matrix} \\ {c}_{j}^{{k}^{*}} = \begin{matrix}max \\ i\end{matrix} {c}_{ij}^{k} ( if c ∈ B ) \\ {a}_{j}^{k -} = \begin{matrix}min \\ i\end{matrix} {a}_{ij}^{k} ( if j ∈ C ) \qquad [ Eqn . 3 ]$$

In Equation 3 above, the ‘B’ represents a benefit criterion and the ‘C’ represents a cost criterion. The cⱼ^{k}* denotes a maximum value in each alternative (Aᵢ^{k}) and, inversely, the aⱼ^{k-} denotes a minimum value in each alternative (Aⱼ^{k}).

The first purpose of using a normalization model is to convert a normalization model of an existing complex TOPSIS into a corresponding similar linear model. The second purpose is to put a range of a normalized fuzzy number between ‘0’ and ‘1’. If modeling this case, data can be determined as in Table 10 below.

TABLE 10

| Decision | Alter- | Criterion | | |
|---|---|---|---|---|
| maker | native | C1 | C2 | C3 |
| D1 | A1 | (0.1, 0.3, 0.5) | (0.56, 0.78, 1) | (0.3, 0.5, 0.7) |
| | A2 | (0.3, 0.5, 0.7) | (0.33, 0.56, | (0.7, 0.9, 1) |
| | | | 0.78) | |
| | A3 | (0.7, 0.9, 1) | (0.56, 0.78, 1) | (0.7, 0.9, 1) |
| D2 | A1 | (0.33, 0.56, | (0.14, 0.43, | (0.7, 0.9, 1) |
| | | 0.78) | 0.71) | |
| | A2 | (0.11, 0.33, | (0.43, 0.71, 1) | (0.1, 0.3, 0.5) |
| | | 0.56) | | |
| | A3 | (0.56, 0.78, 1) | (0.14, 0.43, | (0.5, 0.7, 0.9) |
| | | | 0.71) | |
| D3 | A1 | (0.3, 0.5, 0.7) | (0.56, 0.78, 1) | (0.33, 0.56, |
| | | | | 0.78) |
| | A2 | (0.7, 0.9, 1) | (0.11, 0.33, | (0.56, 0.78, 1) |
| | | | 0.56) | |
| | A3 | (0.5, 0.7, 0.9) | (0.33, 0.56, | (0.11, 0.33, |
| | | | 0.78) | 0.56) |

In step 2, the present disclosure determines a weight (wⱼ^{k}) of a decision maker (k). When determining the weight, the present disclosure uses entropy to avoid subjectivity of the decision maker (k). A weight acquisition process is given as follows.

Firstly, entropy (eⱼ^{k}) for a criterion (j) can be defined in Equation 4 below.

$${e}_{j}^{k} = - {\sum }_{i = 1}^{m} {r}_{ij}^{k} log {r}_{ij}^{k} \qquad [ Eqn . 4 ]$$

At this time, a possible range of the eⱼ^{k} is given in Equation 5 below.

0≦eⱼ^{k}≦log m [Eqn. 5]

Secondly, the present disclosure expresses the entropy (eⱼ^{k}) into a normalization model according to the above condition in Equation 6 below.

$${u}_{j}^{k} = \frac{{e}_{j}^{k}}{log m} \qquad [ Eqn . 6 ]$$

Here, the normalized uⱼ^{k} has a value of 0≦uⱼ^{k}≦1.

Thirdly, a weight (wⱼ^{k}) for the criterion (j) is defined in Equation 7 below.

$${w}_{j}^{k} = 1 - \frac{{u}_{j}^{k}}{{\sum }_{i = 1}^{n} ( 1 - {u}_{i}^{k} )} \qquad [ Eqn . 7 ]$$

After that, the present disclosure applies the determined data of step 1 to the model to determine weight data about a medium criterion of each decision maker as in Table 11 below.

TABLE 11

Criterion

| Decision maker | C1 | C2 | C3 |
|---|---|---|---|
| D1 | (0.44, 0.24, | (0.14, 0.31, | (0.41, 0.45, |
| | 0.22) | 0.40) | 0.38) |
| D2 | (0.27, 0.29, | (0.29, 0.18, | (0.44, 0.53, |
| | 0.31) | 0.33) | 0.36) |
| D3 | (0.30, 0.49, | (0.35, 0.26, | (0.35, 0.26, |
| | 0.39) | 0.30) | 0.30) |

In step 3, the present disclosure determines a positive ideal solution and negative ideal solution of fuzzy as in Equation 8 below.

$$\begin{matrix}{A}^{k +} = \{ ( {max}_{i} {r}_{ij}^{k} \vert j ∈ J ) , ( {min}_{i} {r}_{ij}^{k} \vert j ∈ J ) \vert i ∈ m \} \\ = ⌊ {r}_{1}^{k +} , {r}_{2}^{k +} , … , {r}_{n}^{k +} ⌋ ,\end{matrix} \\ \begin{matrix}{A}^{k -} = \{ ( {min}_{i} {r}_{ij}^{k} \vert j ∈ J ) , ( {max}_{i} {r}_{ij}^{k} \vert j ∈ J ) \vert i ∈ m \} \\ = [ {r}_{i}^{k -} , {r}_{2}^{k -} , … , {r}_{n}^{k -} ]\end{matrix} \qquad [ Eqn . 8 ]$$

Here, the present disclosure determines a maximum value and minimum value of an estimation for each alternative, respectively. After that, if applying the determined model, the present disclosure can determine data of Table 12 below.

TABLE 12

| | |
|---|---|
| A¹⁺ | (0.7, 0.9, 1), (0.56, 0.78, 1), (0.7, 0.9, 1) |
| A¹⁻ | (0.1, 0.3, 0.5), (0.33, 0.56, 0.78), (0.3, 0.5, 0.7) |
| A²⁺ | (0.56, 0.78, 1), (0.43, 0.71, 1), (0.7, 0.9, 1) |
| A²⁻ | (0.11, 0.33, 0.56), (0.14, 0.43, 0.71), (0.1, 0.3, 0.5) |
| A³⁺ | (0.7, 0.9, 1), (0.56, 0.78, 1), (0.56, 0.78, 1) |
| A³⁻ | (0.3, 0.5, 0.7), (0.11, 0.33, 0.56), (0.11, 0.33, 0.56) |

In step 4, the present disclosure determines a separation determination value of a group.

Here, firstly, the present disclosure determines a numerical value from each of a positive ideal solution and a negative ideal solution. If doing so, a weight can become up to two times by TOPSIS and, for this reason, it can be appreciated that decision making is very dependent on the weight.

To improve this, the present disclosure introduces a scheme of determining a weighted Euclidian distance from a positive ideal solution and negative ideal solution of each decision maker (k) to determine the separation determination value using Equation 9 below.

$${d}_{i}^{jk +} = {\sum }_{j = 1}^{n} \sqrt{{w}_{j}^{k} d ( {r}_{j}^{k +} )} ( 1 = 1 , 2 , … m ) \\ {d}_{i}^{jk -} = {\sum }_{j = 1}^{n} \sqrt{{w}_{j}^{k} ( {r}_{ij}^{k} , {r}_{j}^{k -} )} ( i = 1 , 2 , … m ) \qquad [ Eqn . 9 ]$$

Henceforth, if modeling this, the present disclosure can determine data of Table 13 below.

TABLE 13

| | |
|---|---|
| Distance | Decision maker |

| determination | Alternative | D1 | D2 | D3 |
|---|---|---|---|---|
| dᵢ*⁺ | A1 | 0.56 | 0.27 | 0.35 |
| | 0.33 | 0.62 | 0.25 | |
| | 0 | 0.27 | 0.48 | |
| dᵢ*⁻ | A1 | 0.12 | 0.50 | 0.37 |
| | 0.35 | 0.15 | 0.48 | |
| | 0.67 | 0.51 | 0.25 | |

The data is separation determination values determined from alternatives of decision makers.

Secondly, the present disclosure performs a process of summing up numerical values of each group as in Equation 10 below.

dᵢ*⁺=dᵢ¹⁺⊕dᵢ²⁺⊕ . . . ⊕dᵢ^{k+},

dᵢ*⁻=dᵢ¹⁻⊕dᵢ²⁻⊕ . . . ⊕dᵢ^{k-} [Eqn. 10]

Here, if the alternatives of respective decision makers are summed up, Table 14 below can be determined.

TABLE 14

| | d⁺ | d⁻ |
|---|---|---|
| A1 | 1.18 | 0.99 |
| A2 | 1.19 | 0.98 |
| A3 | 0.75 | 1.43 |

In step 5, the present disclosure determines a relative proximity for the ideal solutions using Equation 11 below.

$${C}_{i}^{* +} = \frac{{d}_{i}^{* -}}{{d}_{i}^{* +} + {d}_{i}^{* -}} \qquad [ Eqn . 11 ]$$

Here, C₁*⁺=0.46, C₂*⁺=0.45, and C₃*⁺=0.66 are given.

In step 6, the present disclosure determines preference order using the above data.

Here, it shows order of C₃*⁺, C₁*⁺, and C₃*⁺ by the relative proximity.

From this, preference order becomes A3, A1, and A2. From this, the ‘A3’ is the most optimized alternative.

From the above result, it can be appreciated that there is a difference of order between a method using fuzzy and a method using no fuzzy. This is a reflection of the fuzziness of real data using a fuzzy theory.

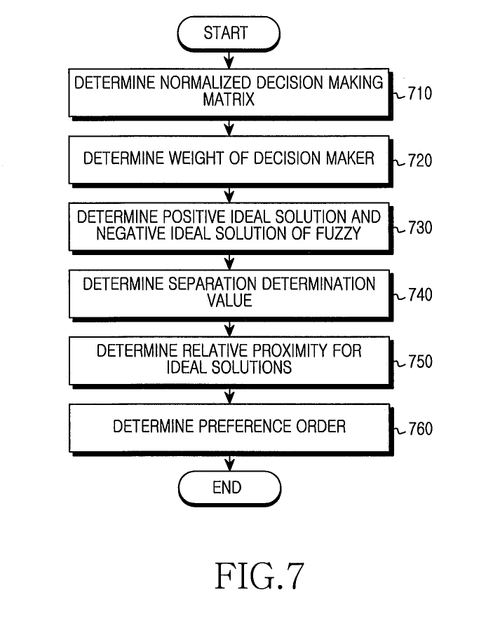

FIG. 7 is a flowchart illustrating a preference order decision process according to an exemplary embodiment of the present disclosure.

Referring to FIG. 7, in step 710, an apparatus of the present disclosure determines a normalized decision making matrix and then, in step 720, determines a weight of a decision maker.

After that, in step 730, the apparatus determines a positive ideal solution and negative ideal solution of fuzzy and, in step 740, determines a separation determination value. And then, in step 750, the apparatus determines a relative proximity for the ideal solutions.

Next, in step 760, the apparatus determines preference order based on the determined values.

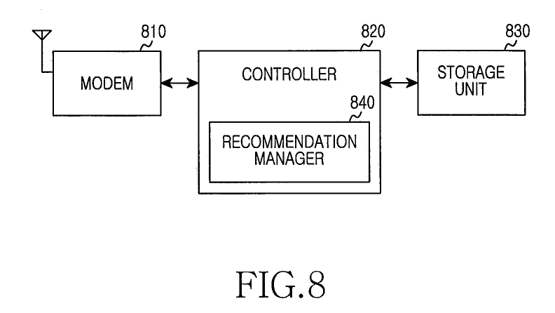

FIG. 8 is a block diagram illustrating a construction of a decision making apparatus according to an exemplary embodiment of the present disclosure.

Referring to FIG. 8, the decision making apparatus includes a modem 810, a controller 820, a storage unit 830, and a recommendation manager 840.

The modem 810 is a module for communicating with other devices, and includes a Radio Frequency (RF) processor, a baseband processor and the like. The RF processor converts a signal that is received through an antenna, into a baseband signal, and provides the baseband signal to the baseband processor. The RF processor converts a baseband signal from the baseband processor into an RF signal such that it can actually transmit on a wireless path and transmits the RF signal through the antenna. A wireless access technology of the modem 810 is not limited.

The controller 820 controls a general operation of the decision making apparatus and, particularly, controls the recommendation manager 840 according to the present disclosure.

The storage unit 830 performs a function of storing a program for controlling the general operation of the decision making apparatus and temporary data generated during program execution.

The recommendation manager 840 determines personnel who will take part in an appointment by a mediator (i.e., a main user). At this time, a criterion of the recommendation personnel is based on a person who is executing the present service and is listed in an address book. After that, if the mediator determines the personnel, the recommendation manager 840 extracts information of each user through existing built ontology. At this time, the extracted information can be helpful in giving a weight when human relationship between respective users is extracted to make an appointment.

After that, the recommendation manager 840 performs a preferential food category recommendation process using a multi-criterion decision making scheme on the basis of user data extracted by the main user. In this process, in place of the recommendation manager 840, an AMS can perform the preferential food category recommendation process using the multi-criterion decision making scheme. The AMS can be other network devices. The AMS can also have a storage unit, a controller, and a wired or wireless modem.

In this process, the recommendation manager 840 or AMS can perform place decision through a database, food category decision through TOPSIS of the present disclosure, and food category acquisition and distance acquisition through an API.

The recommendation manager 840 or AMS can perform a TOPSIS function of the present disclosure. And, the database can be stored in the storage unit 830 or can be included in other network entities.

In the aforementioned block construction, the controller 820 can perform a function of the recommendation manager 840. These are separately constructed and shown so as to distinguish and describe respective functions in the present disclosure.

Accordingly, when a product is actually realized, the product can be constructed so that the controller 820 can process all of the functions of the recommendation manager 840, or can be constructed so that the controller 820 can process only some of the functions.

As described above, exemplary embodiments of the present disclosure have an advantage of being capable of making an optimized decision in simultaneous consideration of situation information of respective users. And, the exemplary embodiments of the present disclosure have an advantage of, by modeling the ambiguity of data of real life by means of a fuzzy theory and entropy, being capable of guaranteeing higher reliability in a decision making step.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for decision making in a decision making apparatus considering a multi-user preference based on a multi-user-criterion group, the method comprising:
determining user information using ontology;
based on the user information, determining an appointed area and an appointed category;
determining appointed candidate places belonging to the appointed area and appointed category; and
determining a final appointed place among the appointed candidate places based on a user preference.

2. The method of claim 1, wherein the user information comprises at least one of a position of a user, a job title, a preferential food, an age, and a specialty.

3. The method of claim 1, wherein the user information is updated considering a weight per user, a Triangular Fuzzy Number (TFN), and entropy.

4. The method of claim 1, wherein determining the appointed area and appointed category based on the user information comprises:
determining the appointed area based on a coordinate of the shortest distance by each user in the user information; and
determining the appointed category through the user information or a user input.

5. The method of claim 1, wherein determining the appointed candidate places belonging to the appointed area and appointed category determines the appointed candidate places belonging to the appointed area and appointed category by means of Internet search or database search.

6. The method of claim 1, wherein the user preference comprises at least one of a price by user, a distance, and a grade, and is determined considering a weight per user, a triangular fuzzy number, and entropy among the user information.

7. An apparatus for decision making considering a multi-user preference based on a multi-user-criterion group, the apparatus comprising:
a communication modem configured to communicate with other nodes;
a controller configured to:
determine user information using ontology,
determine an appointed area and an appointed category based on the user information,
determine appointed candidate places belonging to the appointed area and appointed category, and
determine a final appointed place among the appointed candidate places based on a user preference; and
a storage unit configured to store the user information and user preference.

8. The apparatus of claim 7, wherein the user information comprises at least one of a position of a user, a job title, a preferential food, an age, and a specialty.

9. The apparatus of claim 7, wherein the user information is updated considering a weight per user, a Triangular Fuzzy Number (TFN), and entropy.

10. The apparatus of claim 7, wherein, to determine the appointed area and appointed category based on the user information, the controller is configured to:
determine the appointed area based on a coordinate of the shortest distance by each user in the user information, and
determine the appointed category through the user information or a user input.

11. The apparatus of claim 7, wherein, to determine the appointed candidate places belonging to the appointed area and appointed category, the controller is configured to determine the appointed candidate places belonging to the appointed area and appointed category by means of Internet search or database search.

12. The apparatus of claim 7, wherein the user preference comprises at least one of a price by user, a distance, and a grade, and is determined considering a weight per user, a triangular fuzzy number, and entropy among the user information.

13. The apparatus of claim 7, wherein the controller is configured to determine a small number of appointed candidate places suitable to an appointment using Technique for Order Preference by Similarity to Ideal Solution.

14. A mobile terminal configured to make decisions considering a multi-user preference based on a multi-user-criterion group, the mobile terminal comprising:
a communication modem configured to communicate with other nodes;
a controller configured to:
determine user information using ontology,
determine an appointed area and an appointed category based on the user information,
determine appointed candidate places belonging to the appointed area and appointed category, and
determine a final appointed place among the appointed candidate places based on a user preference; and
a storage unit configured to store the user information and user preference.

15. The mobile terminal of claim 14, wherein the user information comprises at least one of a position of a user, a job title, a preferential food, an age, and a specialty.

16. The mobile terminal of claim 14, wherein the user information is updated considering a weight per user, a Triangular Fuzzy Number (TFN), and entropy.

17. The mobile terminal of claim 14, wherein, to determine the appointed area and appointed category based on the user information, the controller is configured to:
determine the appointed area based on a coordinate of the shortest distance by each user in the user information, and
determine the appointed category through the user information or a user input.

18. The mobile terminal of claim 14, wherein, to determine the appointed candidate places belonging to the appointed area and appointed category, the controller is configured to determine the appointed candidate places belonging to the appointed area and appointed category by means of Internet search or database search.

19. The mobile terminal of claim 14, wherein the user preference comprises at least one of a price by user, a distance, and a grade, and is determined considering a weight per user, a triangular fuzzy number, and entropy among the user information.

20. The mobile terminal of claim 14, wherein the controller is configured to determine a small number of appointed candidate places suitable to an appointment using Technique for Order Preference by Similarity to Ideal Solution.
